(19) United States
(12) Patent Application Publication
(10) Pub. No.: US 2013/0260713 A1
(43) Pub. Date: Oct. 3, 2013

(54) USAGE METERING FOR CUSTOM APPLICATION CONTAINERS

(71) Applicants: Andrew Jong Kein Toy, New York, NY (US); Alexander Allan Trewby, London (GB); David Wei Zhu, Palo Alto, CA (US); Nadim Tawileh, New York, NY (US)

(72) Inventors: Andrew Jong Kein Toy, New York, NY (US); Alexander Allan Trewby, London (GB); David Wei Zhu, Palo Alto, CA (US); Nadim Tawileh, New York, NY (US)

(73) Assignee: Enterproid HK Ltd, Hong Kong (CN)

(21) Appl. No.: 13/555,874

(22) Filed: Jul. 23, 2012

Related U.S. Application Data
(63) Continuation-in-part of application No. 13/432,684, filed on Mar. 28, 2012.

(51) Int. Cl. H04W 4/26

(52) U.S. Cl. 455/406; 455/405

(57) ABSTRACT

Systems and methods for metering network usage based upon an active container are provided herein. Multiple containers that encapsulate respective sets of applications included in an application layer of a mobile operating system can be provided. These containers can interface to the mobile operating system and manage interaction between the mobile operating system and the encapsulated application(s). Usage data facilitated by an application from the respective sets of applications can be identified and the usage data can be associated to an appropriate container, which is detail not available to device-level usage data.

### CROSS-REFERENCE TO RELATED APPLICATIONS

This application is related to U.S. patent application Ser. No. 12/974,478 filed Dec. 21, 2010 and entitled CONTEXTUAL ROLE AWARENESS. This application is a continuation-in-part of U.S. patent application Ser. No. 13/432,684 filed Mar. 28, 2012 and entitled CUSTOM APPLICATION CONTAINER FOR MOBILE OPERATING SYSTEMS AND/OR DEVICES. The entireties of these applications are incorporated herein by reference.

### TECHNICAL FIELD

This disclosure generally relates to tracking or metering usage in connection with configurable containers for an applications layer of a mobile operating system or device.

### BACKGROUND

Today, it is common for businesses and/or enterprises to issue phones or other mobile devices to their employees in order to increase productivity of the employees. In such cases, the employer pays for all usage of the phone on behalf of the employee and also receives billing statements from the carrier describing the usage at a high-level (e.g., device-level). In other common scenarios, the employee might use his or her own personal for business activities as well. In these or other similar arrangements, difficulties arise in cases where the employer does not want to pay for usage by the employee that is of a personal nature or the employee does not want to pay charges on his or her personal phone that result from business activity. Likewise, it is often the case that the employee does not want the employer to have access to personal usage records or to spend time going through the monthly bill to identify certain transactions in order to invoice the employer. Historically, one solution to this conflict was for the employee to maintain two phones, one issued by the employer and one for personal use. However, such is very inconvenient for the end-user.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems and methods disclosed herein relate to metering data usage in a manner that is more granular than conventional device-level metering. A container component can be configured to provide multiple containers that encapsulate respective sets of applications included in an application layer of a mobile operating system. Thus, the multiple containers can interface both to their own respective sets of applications and to the mobile operating system. A metering component can be configured to identify usage data facilitated by an application from the respective sets of applications. The metering component can also be configured to associate the usage data to a container (from among the multiple containers) that encapsulates the application.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a high-level functional block diagram of an example system that provides for metering of network usage based upon an active container;

FIG. 2A illustrates a block diagram of various non-limiting examples of a network transaction;

FIG. 2B illustrates a block diagram of various non-limiting examples of usage data;

FIG. 3 illustrates a high-level functional block diagram of an example system that provides for additional features or aspects in connection with metering of network usage based upon an active container;

FIG. 4A illustrates a block diagram of a conventional system in which usage of network resources is collected at a device-level;

FIG. 4B depicts a block diagram of a system illustrating usage of network resources in accordance with certain aspects of the disclosed subject matter;

FIG. 5 illustrates a high-level functional block diagram of an example system that utilizes a custom container;

FIG. 6 depicts a block diagram of numerous non-limiting examples of core services;

FIG. 7A illustrates a block diagram of various non-limiting examples of dialer extensions;

FIG. 7B illustrates a block diagram of various non-limiting examples of filesystem extensions;

FIG. 8 illustrates a functional block diagram depicting an example system that can provide additional features in connection with utilizing a custom container;

FIG. 9 illustrates an example methodology for providing for metering of network usage based upon an active container;

FIG. 10 illustrates an example methodology for providing for additional features or aspect in connection with metering of network usage based upon an active container;

FIG. 11 illustrates an example wireless communication environment with associated components that can enable operation of an enterprise network in accordance with aspects described herein;

FIG. 12 illustrates a block diagram of a computer operable to execute or implement all or portions of the disclosed architecture; and

FIG. 13 illustrates a schematic block diagram of an exemplary computing environment.

### DETAILED DESCRIPTION

### Persona Overview

A user (or users) of a single mobile device can maintain various personas associated with that user (or users). For example, the user can activate a business persona when utilizing the mobile device in a business context or setting, but can switch the mobile device to a personal persona when using the mobile device in personal context or setting. Upon switching between personas, the user can be exposed to a different operating environment, with different applications available, access to different databases, different security policies, etc. In other words, the multiple personas can represent entirely different ecosystems and/or operating environments. For example, when the business persona is active, applications, data, policies, etc. can be managed by one entity (e.g., the user's employer), while when the personal persona is active, applications, data, policies, etc. can be managed by a different entity (e.g., the user). Because different data sets are used, an application loaded when one persona is active can be distinct from the same application loaded under a second persona. For instance, loading a contacts application can provide a different set of contacts depending upon the active persona, such as business contacts versus personal contacts. Multiple personas can be implemented in the context of a mobile device by way of customizable containers.

### Container Overview

Mobile operating systems today provide a set of core services that are available to applications that are executing on an associated mobile device. A common example of a core service is a dialer. Generally, any application can generate a request to the mobile operating system to request the dialer in order to make a call. The operating system will then interpret the request, generally in accordance with a particular hardcoded implementation, and the dialer will enable the call. For example, a global system for mobile communication (GSM) phone will typically include a dialer that accesses a GSM radio. Likewise, a code division multiple access (CDMA) phone will typically leverage a CDMA radio.

Regardless of the type of phone and/or the implementation of the core service dialer, from the application's perspective, the dialer request that is issued to the mobile operating system is the same. Therefore, any application can access the dialer with a standard request in a seamless manner. However, the dialer core service performs a specific function according to its design implementation. Therefore, any application that seeks to invoke different functions is unable to utilize the core service dialer, and therefore unable to provide such different functionality in a seamless manner.

For example, numerous applications exist to leverage voice-over-Internet-protocol (VOIP) networks to make calls. Such applications can bypass the core services dialer in order to leverage different functionality, but will lose the seamless nature that comes with making calls with the dialer. Therefore, in order to access the VOIP network for a call, the VOIP application will first need to be downloaded and configured/installed by the user. In addition, the VOIP application will need to be invoked prior to making a call every time the VOIP network is desired. Merely dialing numbers with the phones keypad will instead invoke the core service dialer. Likewise, for example, clicking on a phone number included in an email will also invoke the core service dialer, not the VOIP application.

Systems and methods disclosed herein relate to utilizing custom application containers for mobile operating systems and/or mobile devices. The containers can represent environments or ecosystems for a mobile device. A mobile device can have multiple containers representing respective roles or personas of a user or respective roles, personas, or identities for a group of users. For example, the container can encapsulate all or a portion of the applications layer of a mobile operating system or multiple containers can encapsulate respective parts of the applications layer and/or respective sets of applications. In some cases the container can encapsulate a single application included in the applications layer of the mobile operating system. Any requests/calls issued by an application included in a particular container can be intercepted by that container, which can then forward those requests to the operating system or to an extension that can be included in the container. For instance, to continue the example above, if an application initiates a voice or VOIP call, the container that encapsulates that application can take over the dialer features or functions. The container can, e.g., route application messages intended for a particular core service to an extension instead, or pass those messages to the core service. In either case, such can be seamless to both users and the applications.

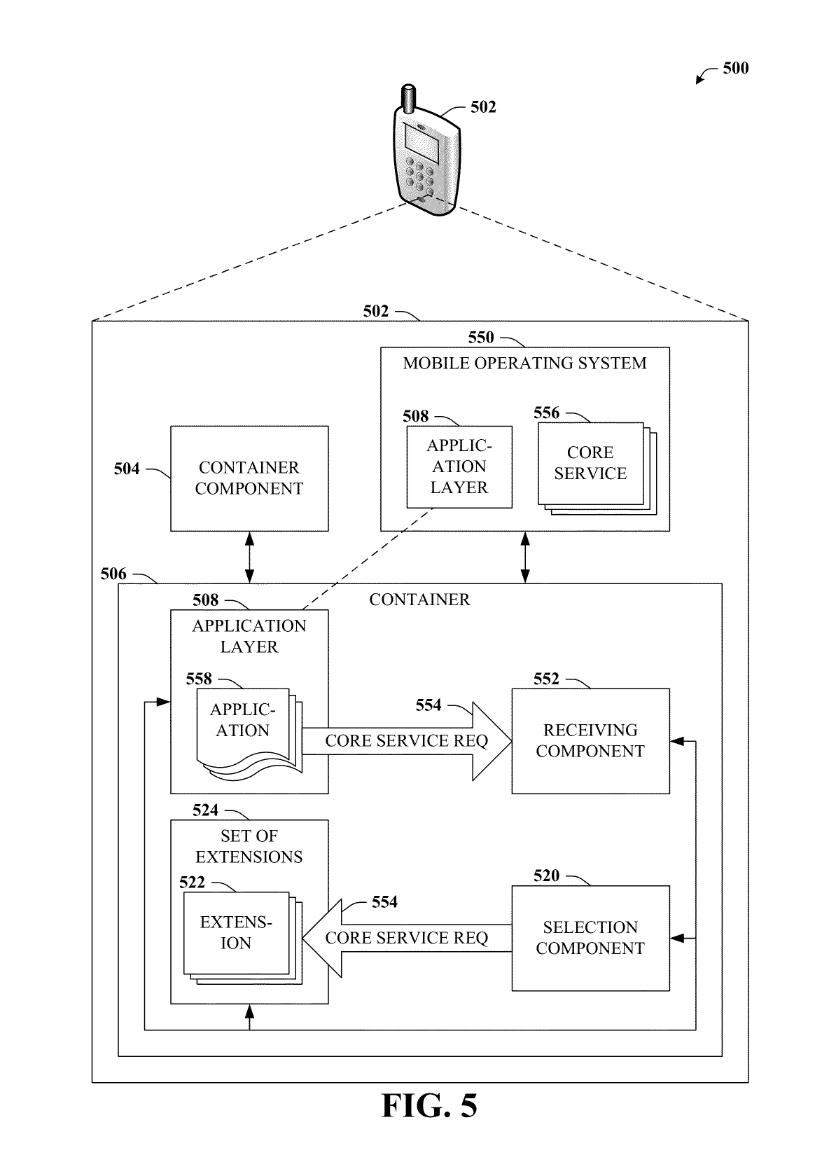

Thus, additional functionality over the existing operating system can be provided by way of various configurable extensions. Moreover, these extensions can be pluggable and/or swappable, and can provide such additional functionality in a seamless manner such that the applications themselves need not be aware. Furthermore, these extensions can be invoked based upon various criteria that can be defined by a policy. Extensions can also be selected (e.g., from among multiple different extensions) based upon the criteria and/or policy. Additional features or aspects associated with custom containers can be found in connection with FIGS. 5-8.

### Data Metering Overview

Given that a single phone or mobile device can maintain independent ecosystems and/or operating environments, it can be advantageous to identify usage with respect to one or another of these operating environments. For example, a business that issues mobile phones to its employees will generally receive billing statements for all usage. In conventional systems, these billing statements are based upon device-level usage. However, with the introduction of multiple personas (e.g., implemented by way of multiple containers), a single mobile device can be used by multiple users or by a single user in multiple contexts. Therefore, it can be advantageous to monitor usage data in a more granular fashion.

In particular, given the ability to “containerize” applications and their associated processes, usage data can be metered on a per-process basis rather than on a per-device basis as exists today. Since all monitored processes can be associated with a particular application and that application can be associated with a particular container, there exists the ability for usage data to be metered on a per-container basis and/or per-persona basis as well. Hence, data usage associated with, e.g., a business persona (and/or business container) can be provided to an account associated with the employer, whereas data usage associated with a personal persona can be provided to an account associated with the employee. Advantageously, neither the employer nor the employee need receive information associated with the other, need not spend time on tracking such expenses, and also need not bear the costs associated with such use.

### Example Metering Based Upon Containers

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

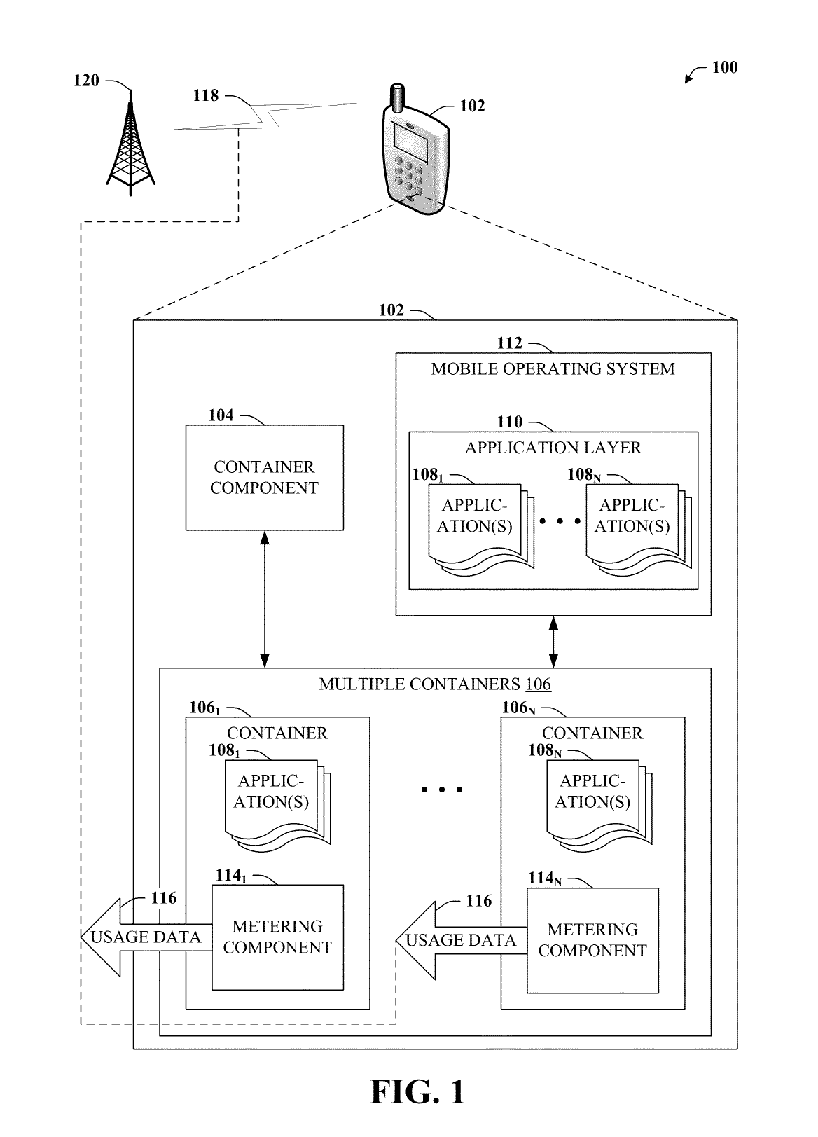

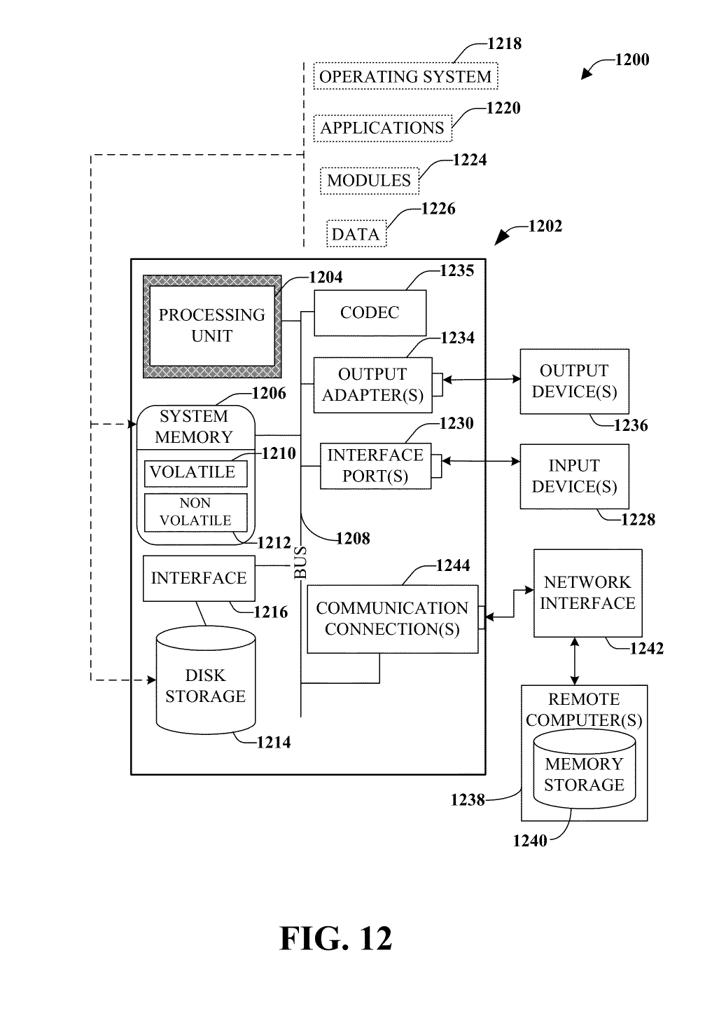

Referring now to drawings, with initial reference to FIG. 1, system 100 is depicted. System 100 provides for metering of network usage based upon an active container. System 100 can include mobile device 102 that can be for example, a smart phone, a tablet, a personal digital assistant (PDA), or substantially any device that utilizes a mobile operating system. Mobile device 102 can include a memory and a processor, examples of which are provided in connection with FIG. 12. Moreover, the processor can be configured to execute various components described herein.

Mobile device 102 can include container component 104 that can be configured to provide multiple containers 106. For example, multiple containers 106 can include substantially any number, N, containers 106₁-106_{N}, which are referred to herein either collectively or individually as container(s) 106, with appropriate subscripts employed generally only when necessary or convenient to highlight various distinctions or to better impart the disclosed concepts. Multiple containers 106 can encapsulate respective sets of applications 108 that can be included in application layer 110 of mobile operating system 112. For example, a first set 108₁ of applications can be encapsulated by a first container 106₁, while a second set 108_{N} of applications can be encapsulated by a second container 106_{N}. A given set 108₁ of applications can include one or more applications installed on mobile device 102. All or a portion of the applications included in set 108₁ of applications can differ from applications included in set 108_{N}, although such is not necessarily the case. Containers 106 can interface to mobile operating system 112 and can therefore manage communication between applications and mobile operating system 112.

Mobile device 102 can also include at least one metering component 114. For example, a metering component 114 can exist for each container 106, as depicted in FIG. 1. However, it is understood that other implementations can exist, such as one or more metering components 114 that monitor various groups of containers. Regardless of the implementation, metering component 114 that can be configured to identify usage data 116. Generally, usage data 116 can be facilitated by an application from the respective sets 108₁-108_{N} of applications. For example, a media application that presents streaming media downloaded from a network can require use of network resources, and therefore can facilitate usage data 116. As another example, an application that invokes a dialer for a voice call can require use of network resources. In some embodiments, usage data 116 can relate to substantially any network transaction 118 that leverages network resources 120 associated with a service provider or carrier for mobile device 102. In many cases, such network transactions 118 can be invoked by, or can invoke, an application included in one of the multiple containers 106.

For example, suppose mobile device 102 is configured with multiple personas for a user. Each persona can be associated with a different container 106, and each container 106 can include a different set 108 of applications. For instance, a first container 106 can be associated with a business persona and that first container 106 can encapsulate only those applications authorized by the employing entity and those applications interact with business data, but not data associated with another persona. A second container 106 can be associated with a personal persona. The second container 106 can include applications selected by the user and these applications as well as associated data can operate independently of the first container.

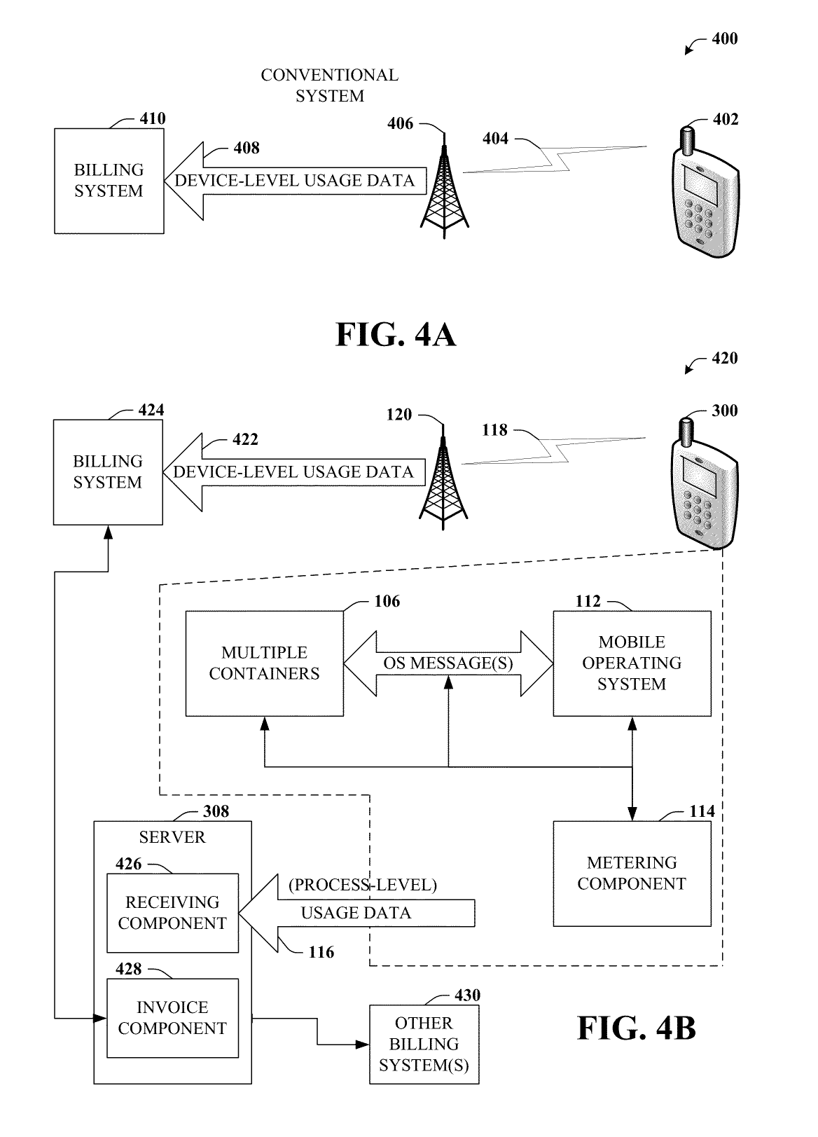

In the above case, mobile device 102 can be involved in network transaction 118 that might incur billable usage. However, the carrier/service provider typically only has access to device-level usage data and therefore is unaware of the contextual role of the mobile device 102. In particular, a given phone call or other network transaction 118 can be invoked when either the business persona or the personal persona is active. This and other information can be included in usage data 116, which is further described with reference to FIGS. 4A and 4B.

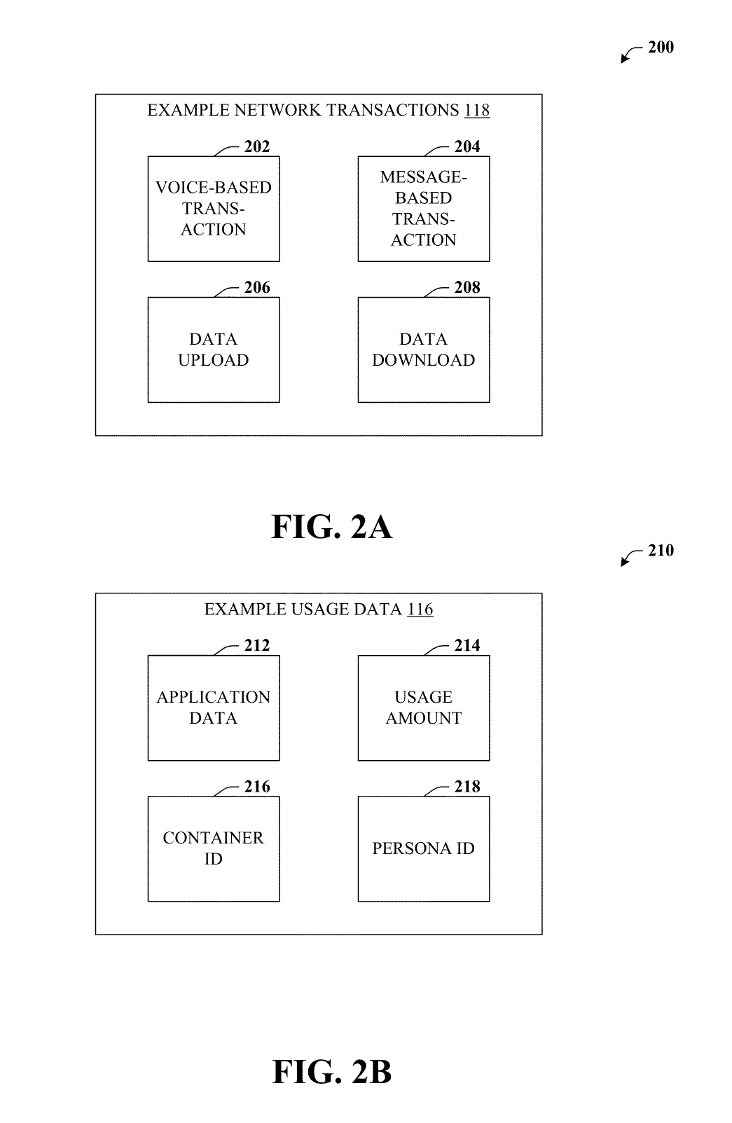

While still referring to FIG. 1, but turning as well to FIGS. 2A and 2B, various examples are provided. With particular reference to FIG. 2A, illustration 200 provides a block diagram of various non-limiting examples of network transaction 118. For instance, network transaction 118 can be a voice-based transaction 202 such as a voice call initiated or received by mobile device 102. As another example, network transaction 118 can be a message-based transaction 204, such as a short message service (SMS) message. Additionally or alternatively, network transaction 118 can be a data upload 206 to a network associated with the carrier/service provider, or a data download 208 from the network. Other examples can exist as network transaction 118 can be substantially any transaction that utilizes network resources 120, and particularly utilization that incurs usage fees or statistics.

Referring to FIG. 2B, illustration 210 provides a block diagram of various non-limiting example of usage data 116. For instance, usage data 116 can include application data 212 such as the application that invoked or responded to network transaction 118 or is otherwise associated with usage data 116. Based upon the implementation, metering component 114 can identify usage data 116 at a process level, which can include detail not available to service providers when collecting their own statistics. Usage data 116 can also relate to usage amount 214 such as a number of minutes associated with a voice call or a number of megabytes associated with data transfers. As with other examples detailed herein, usage amounts 214 can be derived based upon access to process-level detail available to metering component 114.

Usage data 116 can also include container identification 216 and/or persona identification 218. Container identification 216 can relate to a unique reference to the active container 106, which can be the container 106 that encapsulates the particular application that is associated with network transaction 118. Similarly, persona identification 218 can relate to the active persona and/or an account that is associated with the active container 106.

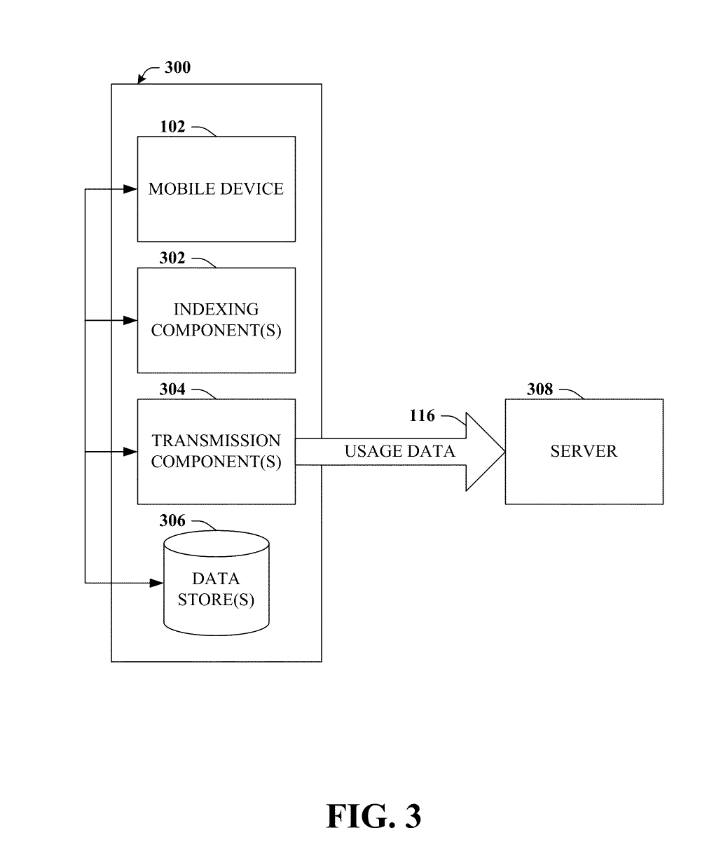

Turning now to FIG. 3, system 300 is depicted. System 300 provides for additional features or aspects in connection with metering of network usage based upon an active container. Generally, system 300 can include all or a portion of mobile device 102 such as container component 104, metering component 114 or other components detailed herein. In addition, system 300 can also include at least one of indexing component(s) 302, transmission component 304, and/or data store 306.

Indexing component 302 can be configured to organize usage data 116 by container 106. For example, indexing component 302 can aggregate usage data 116 associated with a first container 106 and keep such usage data 116 distinct from other usage data 116 that is associated with a second container 106.

Transmission component 304 can be configured to securely upload to server 308 at least a portion of usage data 116 that is associated with at least one container 106. For example, all or a portion of usage data 116 relating to any one container 106 can be uploaded to server 308 or all or a portion of usage data relating to all of the multiple containers 106 can be uploaded. Usage data 116 that is uploaded to server 308 can be periodic (e.g., once per week, once per month, etc.), and therefore such transactions can be mindful of battery life and can conformed or leverage various scheduling resources.

In the interim, usage data 116 (whether sorted by indexing component 302 or not) as well as other data can be stored in data store 306. Data store 306 is intended to be a repository of all or portions of data, data sets, or information described herein or otherwise suitable for use with the disclosed subject matter. Data store 306 can be centralized, either remotely or locally cached, or distributed, potentially across multiple devices and/or schemas. Furthermore, data store 306 can be embodied as substantially any type of memory, including but not limited to volatile or non-volatile, solid state, sequential access, structured access, random access and so on. It should be understood that all or portions of data store 306 can be included in system 300, or can reside in part or entirely remotely from system 300.

It is understood that multiple instances of any or all of indexing component 302, transmission component 304, or data store 306 can exist. For example, each container 106 can include an indexing component 302, a transmission component 304, and/or a data store 306 that is particular to that container 106. Hence, implementations can exist in which each container 106 is self-sufficient and independent, and need not require access to any feature or aspect outside of that particular ecosystem in order to effectuate the disclosed subject matter.

With reference now to FIGS. 4A and 4B, system 400 and 420, respectively, are provided. System 400 relates to a conventional system in which usage of network resources is collected at a device-level. For example, when a conventional mobile device 402 engages in a network transaction 404 with certain network resources 406, such usage can be provided to a billing system 410 associated with the service provider/carrier. This usage is traced based upon device-level usage data 408, and billing system 410 can invoice the customer based upon that information.

In contrast, system 420 relates to usage of network resources in accordance with certain aspects of the disclosed subject matter. In this case mobile device 300 can engage in network transaction 118 that utilizes network resources 120. From such transactions, the service provider can compile device-level usage data 422, which can be routed to a billing system 424. Thus, the service provider can be aware of the total usage by mobile device 300, but with that information alone, is not aware of the context of such usage as detailed herein.

Mobile device 300 can include the various components detailed herein in connection with FIGS. 1 and 3, including, e.g., metering component 114, which can monitor operating system messages that occur between mobile operating system 112 and multiple containers 106. As noted, multiple containers 106 encapsulate applications that exist in the application layer of mobile operating system 112. Thus, multiple containers 106 can intercept and/or forward messages to or from these applications.

Hence, metering component 114 can monitor transactions at the process-level and can construct usage data 116, which can be sorted according to container 106 (e.g., by indexing component 302) and transmitted to server 308 (e.g., by transmission component 304). Usage data 116 can include process-level detail that is not normally available to the service provider. For example, usage data 116 can include information as to which container 106 of the multiple containers 106 is active during a given network transaction 118. As a result, if the service provider maintains different accounts for different containers 106 and/or personas associated with mobile device 300, usage data 116 can be employed to provide the information to the appropriate account.

To these or other related ends, server 308 can include receiving component 426 that can be configured to receive usage data (e.g., usage data 116) associated with a mobile device (e.g., mobile device 300). The usage data can relate to a particular container (e.g., container 106) among multiple containers (e.g., multiple containers 106) residing on the mobile device. The particular container can encapsulate a set of applications (e.g., set 108₁ or 108_{N} of applications) included in an application layer of a mobile operating system (e.g., mobile operating system 112).

Server 308 can also include invoice component 428 that can be configured to provide usage data 116 to a billing system associated with the particular container. Hence, usage data 116 or other related information can be provided to billing system 424 to supplement device-level usage data 422. In some embodiments, usage data 116 or other related information can be provided to other billing system(s) 430, e.g., billing systems associated with server 308.

### Example Custom Containers

Referring now to FIG. 5, system 500 that utilizes a custom container is depicted. System 500 can include mobile device 502 (or 102 or 300) that can be for example, a smart phone, a tablet, a personal digital assistant (PDA), or substantially any device that utilizes a mobile operating system. Mobile device 502 can include a memory and a processor, examples of which are provided in connection with FIG. 12. Moreover, the processor can be configured to execute various components described herein.

Mobile device 502 can include container component 504 that can be configured to provide container 506. Container 506 can be configured to encapsulate application layer 508 of mobile operating system 510 and to interface to mobile operating system 510. By encapsulating application layer 508, container 506 can act as a proxy for any application (e.g., application(s) 518) included in application layer 508, and particularly as a proxy for calls to mobile operating system 510 made by any of these applications.

In certain embodiments, container 506 can include receiving component 512 and selection component 520. Receiving component 512 can be configured to receive core service request 514 to access a core service 516 of mobile operating system 510 from an application 518 included in container 506. For example, a camera application (e.g., application 518) might issue core service request 514 to access the filesystem (e.g., core service 516) in order to save a photo. In conventional systems, such requests will be received by the operating system, however, in accordance with the disclosed subject matter, container 506, and particularly receiving component 512, can intercept the core service request 514.

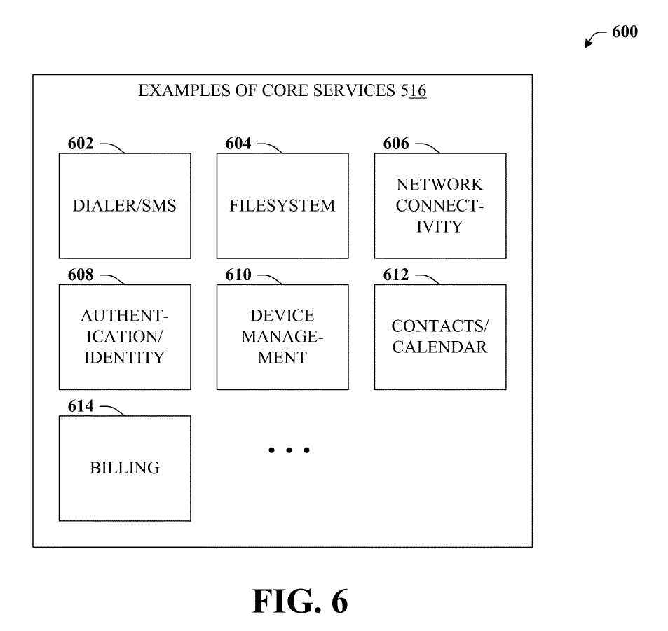

While still referring to FIG. 5, but turning now as well to FIG. 6, various examples of core services are provided by illustration 600. For example, a common core service 516 provided by mobile operating system 510 can be a dialer function or a short message service (SMS) function, which is represented by reference numeral 602. The dialer function typically handles outgoing calls from mobile device 502. The SMS function typically handles, e.g., text messages. Another example core service 516 is filesystem 604. Filesystem 604 provides functions associated with accessing or storing information. For instance, applications 518 typically access filesystem 604 core service to save an email attachment or a photo snapped by a camera of mobile device 502. Network connectivity 606 represents yet another example of a core service 516 provided by mobile operating system 510. For example, a virtual private network (VPN) or a proxy network might represent network connectivity 606.

Authentication/Identity 608 (e.g., passwords, credentials, biometric, etc.) represents still another example core service 516. Device management 610 can also be a core service 516 provided by mobile operating system 510 as can functions associated with contacts/calendar 612. Still another example can include billing 614. For example, various core services 516 and/or extensions 522 can relate to providing usage data 116 to a cloud server or to an associated service provider or carrier. It is understood that the examples of core services 516 provided herein are intended to be non-limiting, and numerous other examples are possible.

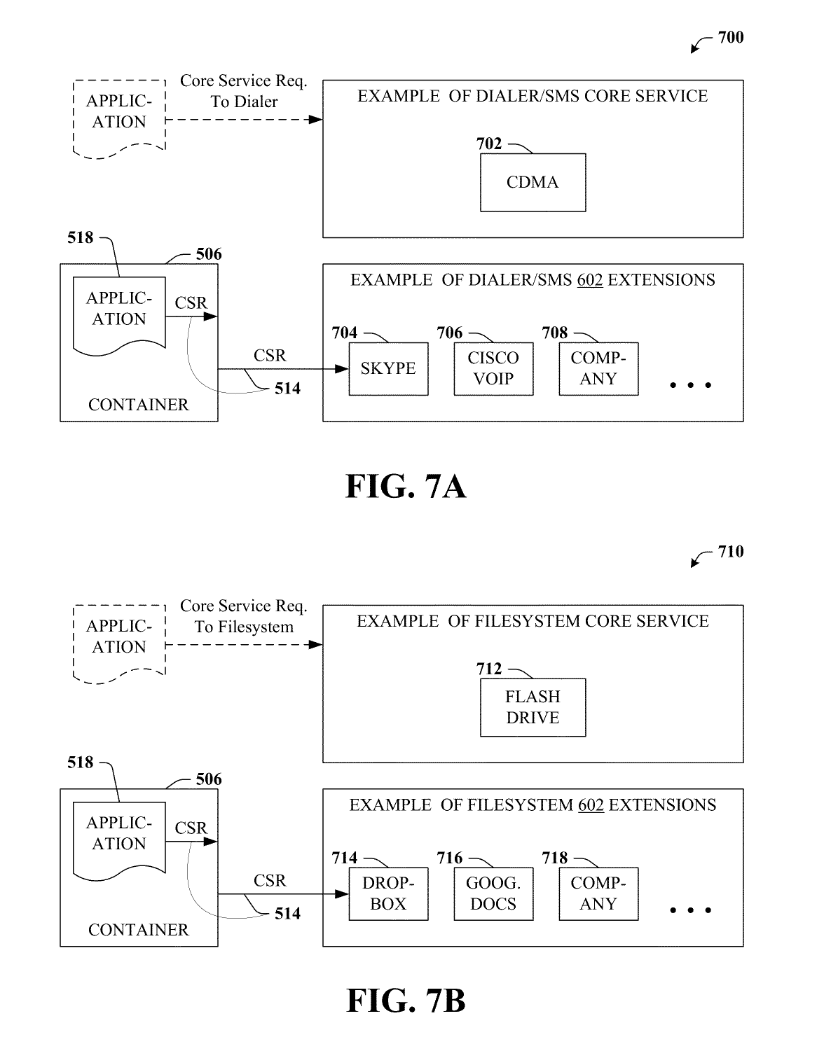

Still referring to FIG. 5, selection component 520 can be configured to select an extension 522 associated with core service request 514. In some embodiments, extension 522 can be selected from among many related or unrelated extensions, which is represented by set of extensions 524 and is further detailed with reference to FIG. 7. Selection component 520 can further be configured to route the core service request 514 to the selected extension 522. As such set of extensions 524 and/or an individual extension 522 can be thought of as a pluggable, swappable module that can seamlessly (both to users and applications 518) integrate with mobile operating system 510 in order to provide additional functionality and/or security or control. Such can be accomplished by virtualizing one or more core services 516 associated with core service request 514. Extension 522 can represent such a virtualization.

For example, turning to FIGS. 7A and 7B, example scenarios are provided for two specific core services. Illustration 600 of FIG. 6 provides numerous non-limiting example of core services 516. From these numerous examples, the first two are now described in more detail and it is appreciated that one of skill in the art can readily understand similar features can be applicable to other core services 516 provided by mobile operating system 510.

With particular reference to FIG. 7A, illustration 700 depicts an example scenario in which the core service call relates to a core service dialer (e.g., dialer/SMS 602). In conventional approaches (depicted in the upper portion of illustration 700) an application running on the mobile device will make a core service request to the dialer core service. Depending on the implementation of the mobile device, this core service request will invoke the standard dialer function, which in this case is a code division multiple access radio represented by CDMA 702. Therefore, all applications will use CDMA 702 when invoking the core service dialer.

In contrast, the lower portion of illustration 700 depicts an example embodiment of the disclosed subject matter. Application 518 can issue core service request 514. However, rather than going to the operating system to invoke the standard dialer, core service request 514 can be intercepted by container 506. In particular, receiving component 512 included in container 506 can intercept core service request 514. Likewise, selection component 520 can select the appropriate extension 522 in which to forward core service request 514.

Since this particular core service request 514 is related to the dialer core service (e.g., dialer/SMS 602), selection component 520 can select from among various extensions 522 that are also related to dialer functionality. For example, Skype service 704, Cisco VOIP service 706, and a company VOIP service 708 are straightforward examples. In this example, Skype 704 is selected as the appropriate extension. As a result, any activity or behavior that would in conventional systems have invoked CDMA 702 will now instead invoke Skype. Application 518 need not be related to or even aware that Skype services are being leveraged. Hence, virtually limitless additional functionality can be provided to a given mobile device in a manner that is seamless to users and applications. Moreover, such additional functionality can be tailored to particular needs such as, e.g., enterprise policies and procedures or the like.

With particular reference to FIG. 7B, illustration 710 depicts an example scenario in which the core service call relates to a filesystem request (e.g., filesystem 604). In conventional approaches (depicted in the upper portion of illustration 710) an application running on the mobile device will make a core service request to the filesystem for a variety of reasons such as to save data (e.g., email, contacts, photos) or otherwise access saved data. Depending on the implementation of the mobile device, this core service request will invoke the standard filesystem function, which in this case relates to a filesystem structure included on flash drive 712.

In contrast, the lower portion of illustration 710 depicts an example embodiment of the disclosed subject matter. Application 518 can issue core service request 514. However, rather than going to the operating system in order to determine where to save or access data, core service request 514 can be intercepted by container 506 (e.g., by way of receiving component 512). Likewise, container 506 (e.g., by way of selection component 520) can select the appropriate extension 522 in which to forward core service request 514.

As this particular core service request 514 is related to the filesystem (e.g., filesystem 604), selection component 520 can select from among various extensions 522 that are also related to filesystem functionality. For example, rather than saving the associated data to flash drive 712, which would be done conventionally, data can be saved to (or retrieved from), e.g., a cloud. Common examples of cloud-based storage are Dropbox 714, GoogleDocs 716, or a company-based facility 718.

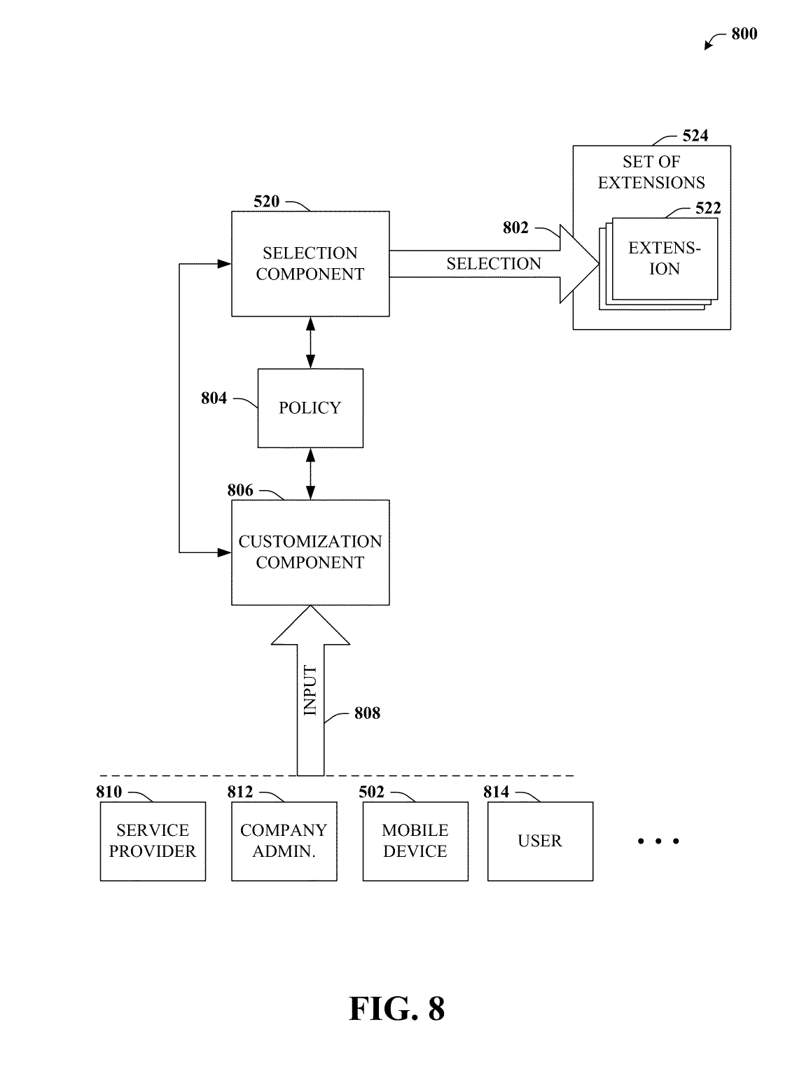

Thus, it is understood that for any given core service 516 provided by mobile operating system 510, virtually any number of extensions 522 can exist that can seamlessly replace the functionality of that core service and any one of those extensions 522 can be selected based upon the configuration of container 506. Therefore, in certain embodiments, selection component 520 can select the appropriate extension 522 based upon a policy, as further detailed in connection with FIG. 8.

With reference now to FIG. 8, system 800 is depicted. System 800 provides additional features in connection with utilizing a custom container. System 800 can include selection component 520 as well as all or a portion of other components or features detailed herein. As described in connection with system 500 of FIG. 5, selection component 520 can be configured to select extension 522 associated with core service request 514. Such is depicted here as selection 802.

In some embodiments, selection component 520 can be configured to select extension 522 based upon policy 804 that is included in or accessible to container 506. Furthermore, system 800 can also include customization component 806 that can be included in container 506. Customization component can configure policy 804 based upon input 808. Such input 808 can be received by customization component 806 from service provider 810 (e.g., an entity that provides the extensions 522 or related services or an entity that provides phone communications services), from a company administrator 812 (e.g., an entity that manages phone services for its employees), from mobile device 502 (e.g., from a different persona included in mobile device 502, such as an admin persona or the like), from user 814 (e.g., the owner/operator of mobile device 502), and so on.

It is understood, that a single mobile device can include various personas, which are further detailed herein by reference. However, briefly, a mobile device (e.g., mobile device 502) can include multiple personas for one or a group of users, where a persona relates to a contextual role of the user or group of users. For example, a particular user can maintain an enterprise persona, a personal persona, a gaming persona or the like. Each persona can be independent of others, thus, data such as contacts or the particular set of applications installed, etc. can be distinct, not overlapping and not being accessible from a different persona. Such data that is accessed by way of a core service call can therefore differ based upon which persona is active. In addition, the container associated with a given persona can therefore be different from the container associated with a different persona. Hence, not only can data change when switching from one role to another (e.g., the results of an application that displays contacts will change, seamlessly to the application), the container can change as well. Thus, changing personas can change the policy for how particular core service calls are handled. For instance, the same application that displays contacts might not only pull those contacts from a different database, but might do so in a different manner (e.g., collect data from a cloud server rather than a local flash drive). In addition, changing personas can change billing features. For instance, data usage associated with a business persona can be distinguished from data usage associated with a personal persona, even though the same mobile device is being used. Data usage associated with the business persona can be provided to an associated carrier, and such can be used to bill the business. On the other hand, the user (but not the business) can receive billing information for data usage that occurred when the personal persona is active.

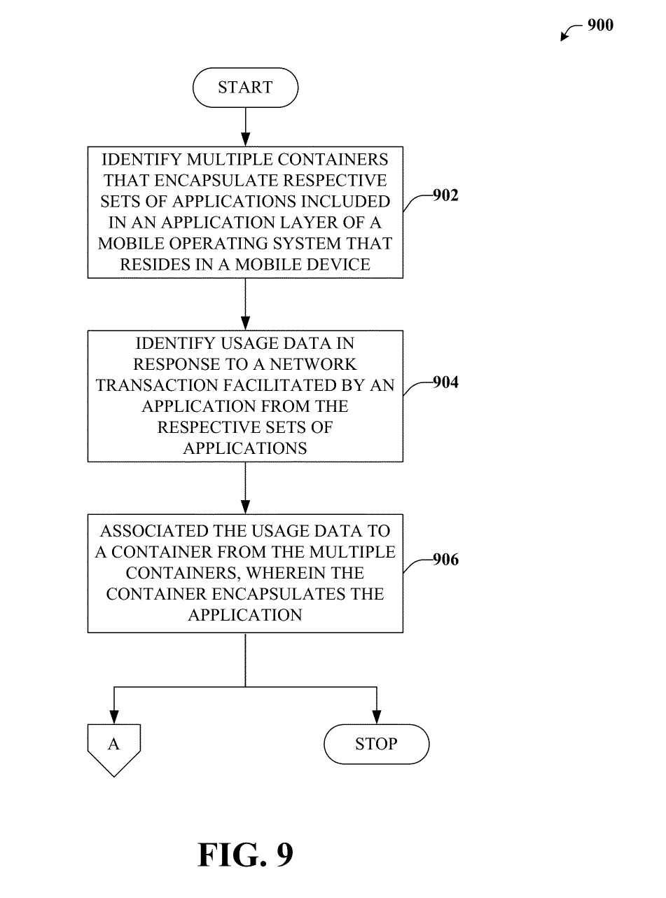

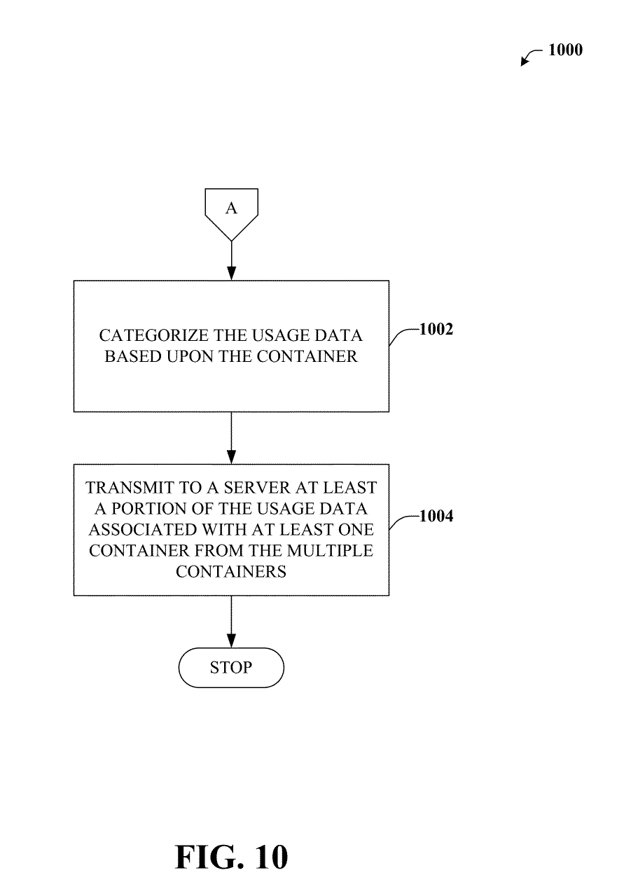

FIGS. 9 and 10 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers

Turning now to FIG. 9, exemplary method 900 is illustrated. Method 900 can provide for metering of network usage based upon an active container. Generally, at reference numeral 902, multiple containers can be identified. These multiple containers can encapsulate respective sets of applications included in an application layer of a mobile operating system that resides in a mobile device. By encapsulating all or portions of the application layer, process-level detail is available to the multiple containers.

At reference numeral 904, usage data can be identified in response to a network transaction facilitated by an application from the respective sets of applications. For example, if the application initiates a, e.g., data download, usage data associated with that download can be collected and/or store.

At reference numeral 906, the usage data can be associated to a container from the multiple containers, wherein the container encapsulates the application. For example, the container that is active at the time when the application initiates the network transaction (e.g., a data download, a voice call, etc.) can be identified, and that container can be associated with the usage data that results from the network transaction.

Referring now to FIG. 10, exemplary method 1000 is depicted. Method 1000 can provide for additional features or aspect in connection with metering of network usage based upon an active container. At reference numeral 1002, the usage data derived at reference numeral 904 of FIG. 9 can be categorized according to the container. For instance, usage data associated with a first container can be aggregated together, while usage data associated with a second container can be aggregated separately.

At reference numeral 1004, at least a portion of the usage data associated with at least one container from the multiple containers can be transmitted to a server. For example, all or a portion of usage data related to a particular container can be transmitted to the server or all or a portion of usage data related to many containers can be transmitted to the server.

### Example Operating Environments

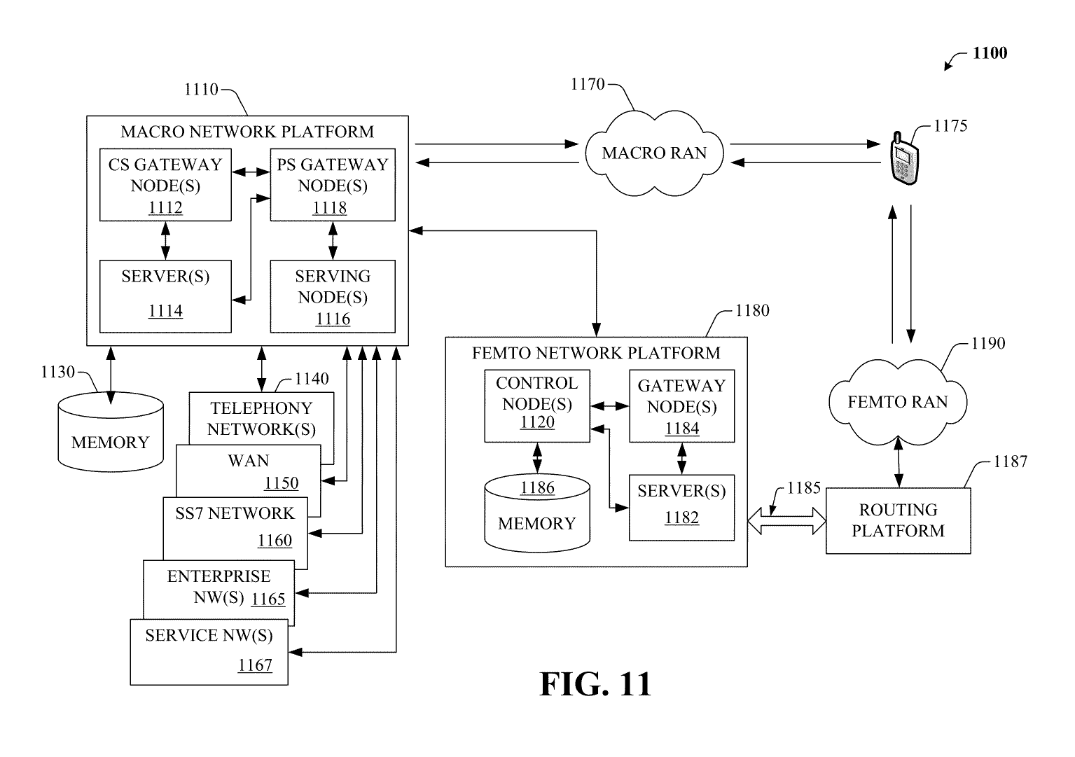

To provide further context for various aspects of the subject specification, FIG. 11 illustrates an example wireless communication environment 1100, with associated components that can enable operation of a femtocell enterprise network in accordance with aspects described herein. Wireless communication environment 1100 includes two wireless network platforms: (i) A macro network platform 1110 that serves, or facilitates communication) with user equipment 1175 via a macro radio access network (RAN) 1170. It should be appreciated that in cellular wireless technologies (e.g., 4G, 3GPP UMTS, HSPA, 3GPP LTE, 3GPP UMB), macro network platform 1110 is embodied in a Core Network. (ii) A femto network platform 1180, which can provide communication with UE 1175 through a femto RAN 1190, linked to the femto network platform 1180 through a routing platform 112 via backhaul pipe(s) 1185. It should be appreciated that femto network platform 1180 typically offloads UE 1175 from macro network, once UE 1175 attaches (e.g., through macro-to-femto handover, or via a scan of channel resources in idle mode) to femto RAN.

It is noted that RAN includes base station(s), or access point(s), and its associated electronic circuitry and deployment site(s), in addition to a wireless radio link operated in accordance with the base station(s). Accordingly, macro RAN 1170 can comprise various coverage cells like cell 1105, while femto RAN 1190 can comprise multiple femto access points. As mentioned above, it is to be appreciated that deployment density in femto RAN 1190 is substantially higher than in macro RAN 1170.

Generally, both macro and femto network platforms 1110 and 1180 include components, e.g., nodes, gateways, interfaces, servers, or platforms, that facilitate both packet-switched (PS) (e.g., internet protocol (IP), frame relay, asynchronous transfer mode (ATM)) and circuit-switched (CS) traffic (e.g., voice and data) and control generation for networked wireless communication. In an aspect of the subject innovation, macro network platform 1110 includes CS gateway node(s) 1112 which can interface CS traffic received from legacy networks like telephony network(s) 1140 (e.g., public switched telephone network (PSTN), or public land mobile network (PLMN)) or a SS7 network 1160. Circuit switched gateway 1112 can authorize and authenticate traffic (e.g., voice) arising from such networks. Additionally, CS gateway 1112 can access mobility, or roaming, data generated through SS7 network 1160; for instance, mobility data stored in a VLR, which can reside in memory 1130. Moreover, CS gateway node(s) 1112 interfaces CS-based traffic and signaling and gateway node(s) 1118. As an example, in a 3GPP UMTS network, gateway node(s) 1118 can be embodied in gateway GPRS support node(s) (GGSN).

In addition to receiving and processing CS-switched traffic and signaling, gateway node(s) 1118 can authorize and authenticate PS-based data sessions with served (e.g., through macro RAN) wireless devices. Data sessions can include traffic exchange with networks external to the macro network platform 1110, like wide area network(s) (WANs) 1150; it should be appreciated that local area network(s) (LANs) can also be interfaced with macro network platform 1110 through gateway node(s) 1118. Gateway node(s) 1118 generates packet data contexts when a data session is established. To that end, in an aspect, gateway node(s) 1118 can include a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can include multiple flows that can be generated through server(s) 1114. It is to be noted that in 3GPP UMTS network(s), gateway node(s) 1118 (e.g., GGSN) and tunnel interface (e.g., TTG) comprise a packet data gateway (PDG).

Macro network platform 1110 also includes serving node(s) 1116 that convey the various packetized flows of information or data streams, received through gateway node(s) 1118. As an example, in a 3GPP UMTS network, serving node(s) can be embodied in serving GPRS support node(s) (SGSN).

As indicated above, server(s) 1114 in macro network platform 1110 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can include add-on features to standard services provided by macro network platform 1110. Data streams can be conveyed to gateway node(s) 1118 for authorization/authentication and initiation of a data session, and to serving node(s) 1116 for communication thereafter. Server(s) 1114 can also effect security (e.g., implement one or more firewalls) of macro network platform 1110 to ensure network's operation and data integrity in addition to authorization and authentication procedures that CS gateway node(s) 1112 and gateway node(s) 1118 can enact. Moreover, server(s) 1114 can provision services from external network(s), e.g., WAN 1150, or Global Positioning System (GPS) network(s) (not shown). It is to be noted that server(s) 1114 can include one or more processor configured to confer at least in part the functionality of macro network platform 1110. To that end, the one or more processor can execute code instructions stored in memory 1130, for example.

In example wireless environment 1100, memory 1130 stores information related to operation of macro network platform 1110. Information can include business data associated with subscribers; market plans and strategies, e.g., promotional campaigns, business partnerships; operational data for mobile devices served through macro network platform; service and privacy policies; end-user service logs for law enforcement; and so forth. Memory 1130 can also store information from at least one of telephony network(s) 1140, WAN(s) 1150, or SS7 network 1160, enterprise NW(s) 1165, or service NW(s) 1167.

Femto gateway node(s) 1184 have substantially the same functionality as PS gateway node(s) 1118. Additionally, femto gateway node(s) 1184 can also include substantially all functionality of serving node(s) 1116. In an aspect, femto gateway node(s) 1184 facilitates handover resolution, e.g., assessment and execution. Further, control node(s) 1120 can receive handover requests and relay them to a handover component (not shown) via gateway node(s) 1184. According to an aspect, control node(s) 1120 can support RNC capabilities.

Server(s) 1182 have substantially the same functionality as described in connection with server(s) 1114. In an aspect, server(s) 1182 can execute multiple application(s) that provide service (e.g., voice and data) to wireless devices served through femto RAN 1190. Server(s) 1182 can also provide security features to femto network platform. In addition, server(s) 1182 can manage (e.g., schedule, queue, format . . . ) substantially all packetized flows (e.g., IP-based, frame relay-based, ATM-based) it generates in addition to data received from macro network platform 1110. It is to be noted that server(s) 1182 can include one or more processor configured to confer at least in part the functionality of macro network platform 1110. To that end, the one or more processor can execute code instructions stored in memory 1186, for example.

Memory 1186 can include information relevant to operation of the various components of femto network platform 1180. For example operational information that can be stored in memory 1186 can comprise, but is not limited to, subscriber information; contracted services; maintenance and service records; femto cell configuration (e.g., devices served through femto RAN 1190; access control lists, or white lists); service policies and specifications; privacy policies; add-on features; and so forth.

It is noted that femto network platform 1180 and macro network platform 1110 can be functionally connected through one or more reference link(s) or reference interface(s). In addition, femto network platform 1180 can be functionally coupled directly (not illustrated) to one or more of external network(s) 1140, 1150, 1160, 1165 or 1167. Reference link(s) or interface(s) can functionally link at least one of gateway node(s) 1184 or server(s) 1186 to the one or more external networks 1140, 1150, 1160, 1165 or 1167. The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. In addition, according to present innovations, codec 1205 may include at least one of an encoder or decoder, wherein the at least one of an encoder or decoder may consist of hardware, a combination of hardware and software, or software. Although, codec 1205 is depicted as a separate component, codec 1205 may be contained within non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1202 may also include removable/non-removable, volatile/non-volatile computer storage medium. FIG. 12 illustrates, for example, disk storage 1214. Disk storage 1214 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port may be used to provide input to computer 1202 and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

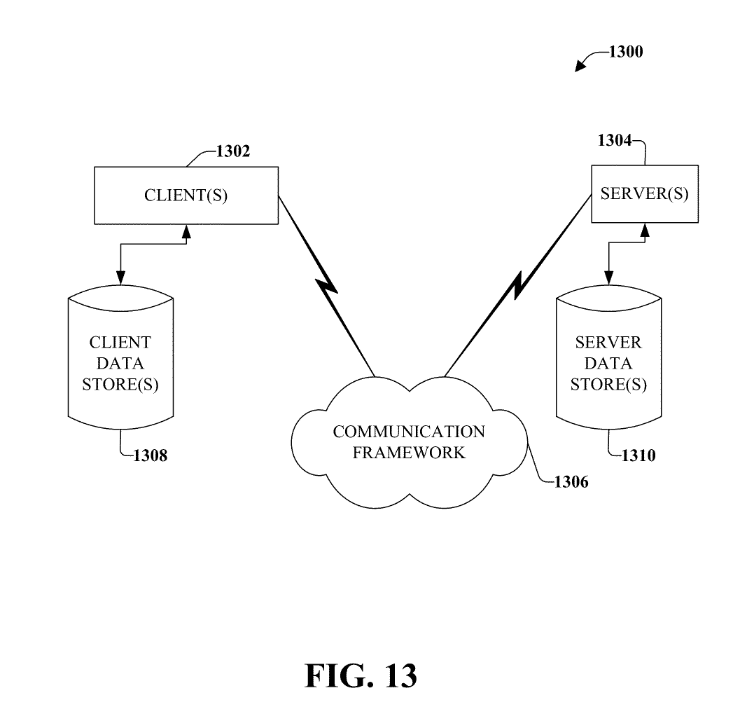

Referring now to FIG. 13, there is illustrated a schematic block diagram of a computing environment 1300 in accordance with this specification. The system 1300 includes one or more client(s) 1302 (e.g., laptops, smart phones, PDAs, media players, computers, portable electronic devices, tablets, and the like). The client(s) 1302 can be hardware and/or software (e.g., threads, processes, computing devices). The system 1300 also includes one or more server(s) 1304. The server(s) 1304 can also be hardware or hardware in combination with software (e.g., threads, processes, computing devices). The servers 1304 can house threads to perform transformations by employing aspects of this disclosure, for example. One possible communication between a client 1302 and a server 1304 can be in the form of a data packet transmitted between two or more computer processes wherein the data packet may include video data. The data packet can include a cookie and/or associated contextual information, for example. The system 1300 includes a communication framework 1306 (e.g., a global communication network such as the Internet, or mobile network(s)) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

In one embodiment, a client 1302 can transfer an encoded file, in accordance with the disclosed subject matter, to server 1304. Server 1304 can store the file, decode the file, or transmit the file to another client 1302. It is to be appreciated, that a client 1302 can also transfer uncompressed file to a server 1304 and server 1304 can compress the file in accordance with the disclosed subject matter. Likewise, server 1304 can encode video information and transmit the information via communication framework 1306 to one or more clients 1302.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

What is claimed is:

1. A system, comprising:
a mobile device including a processor that facilitates execution of computer executable components stored in a memory, the computer executable components comprising:
a container component that provides multiple containers that encapsulate respective sets of applications included in an application layer of a mobile operating system, and respectively interface to the mobile operating system; and
a metering component that identifies usage data facilitated by an application from the respective sets of applications, and associates the usage data to a container, among the multiple containers, that encapsulates the application.

2. The system of claim 1, wherein the container intercepts a message transmitted to the mobile operating system by the application.

3. The system of claim 2, wherein the container reroutes the message to an extension that virtualizes a service associated with the message.

4. The system of claim 1, wherein the usage data relates to a network transaction that leverages network resources associated with a carrier for the mobile device.

5. The system of claim 4, wherein the network transaction is at least one of a voice-based transaction, a message-based transaction or short message service (SMS) transaction, a data upload to a network associated with the carrier, or a data download from the network.

6. The system of claim 1, wherein the metering component identifies usage data at a process level for the application.

7. The system of claim 1, wherein the usage data includes at least one of application data, a usage amount, an identification of the container, or an identification of a role, persona, or account associated with the container.

8. The system of claim 1, wherein the computer executable components further comprise an indexing component that organizes the usage data by container.

9. The system of claim 1, wherein the computer executable components further comprise a transmission component that securely uploads to a server at least a portion of the usage data associated with at least one container from the multiple containers.

10. A system, comprising:
a server including a processor that facilitates execution of computer executable components stored in a memory, the computer executable components comprising:
a receiving component that receives usage data associated with a mobile device, wherein the usage data relates to a particular container among multiple containers residing on the mobile device, and wherein the particular container encapsulates a set of applications included in an application layer of a mobile operating system included in the mobile device; and
an invoice component that provides the usage data to a billing system.

11. The system of claim 10, wherein the set of applications includes at least one application that is active while the usage data is identified.

12. The system of claim 10, wherein the billing system is associated with a network provider for the mobile device.

13. The system of claim 12, wherein the particular container is associated with an account or container identification maintained by the network provider.

14. The system of claim 10, wherein the billing system is associated with a billing vendor that aggregates usage information for at least one network provider.

15. A method, comprising:
identifying, by a system including at least one processor, multiple containers that encapsulate respective sets of applications included in an application layer of a mobile operating system that resides in a mobile device;
identifying usage data in response to a network transaction facilitated by an application from the respective sets of applications, wherein the usage data is identified in response to examining processes of the application; and
associating the usage data to a container from the multiple containers, wherein the container encapsulates the application.

16. The method of claim 15, further comprising intercepting, by the container, a message transmitted to the mobile operating system by the application.

17. The method of claim 16, further comprising routing the message to an extension that virtualizes a service associated with the message.

18. The method of claim 15, wherein the identifying usage data is in response to at least one of a voice-based transaction, a message-based transaction or short message service (SMS) transaction, a data upload to a network, or a data download from the network.

19. The method of claim 15, further comprising categorizing the usage data based upon the container.

20. The method of claim 15, further comprising transmitting to a server at least a portion of the usage data associated with at least one container from the multiple containers.
